(19) United States
(12) Patent Application Publication
(10) Pub. No.: US 2011/0039707 A1
(43) Pub. Date: Feb. 17, 2011

(54) SUPERCONDUCTING MAGNET SYSTEMS

(75) Inventors: Stephen Burgess, Oxfordshire (GB); Nicholas William Kerley, Oxfordshire (GB)

Correspondence Address: Agilent Technologies, Inc. in care of:;CPA Global, P. O. Box 52050, Minneapolis, MN, 55402, US

(73) Assignee: MAGNEX SCIENTIFIC LIMITED, Yarnton, Oxfordshire (GB)

(21) Appl. No.: 12/094,077

(22) PCT Filed: Nov. 16, 2006
(86) PCT No.: PCT/GB2006/050392

§ 371 Date: Oct. 16, 2008

(30) Foreign Application Priority Data
Nov. 18, 2005 (GB) 0523499.2

(51) Int. Cl. H01F 6/04; F25B 19/00

(52) U.S. Cl. 505/163; 62/51.1; 335/216

(57) ABSTRACT

A superconducting magnet system comprises an annular cryogenic vessel (1) having an outer vacuum container (2) and containing a superconducting magnet (3) within an annular reservoir (4) containing liquid helium. A cryocooler (5) has a first stage (7) linked by a thermal link (9) to a thermal shield (6) within the vacuum space surrounding the reservoir (4) and a second stage (8) that serves to recondense evaporating helium gas from the reservoir (4). In the absence of special measures, such a cryocooled shield (6) would warm up quickly in the event of a power failure and would radiate heat onto the reservoir (4) causing all of the liquid helium to evaporate. However an inertial shield (11) is provided between the reservoir (4) and the thermal shield (6) in such a position that the outgoing helium gas from the reservoir (4) carries away the heat being transferred to the inertial shield (11) from the thermal shield (6) and thus slows down the rate at which the thermal inertial shield (11) warms up. Such a system does not require cryogenic fluid refilling at intervals and is less sensitive to the effect of a power failure or malfunction than existing systems.

This invention relates to superconducting magnet systems.

Superconducting magnet systems, such as are used in nuclear magnetic resonance (NMR) spectroscopy and magnetic resonance imaging (MRI) and Fourier-transform mass spectroscopy (FTMS), incorporate a cryogenic vessel for containing the cryogenic fluid to maintain the system at the required very low temperature. The superconducting magnets for such systems are usually wound with low temperature superconducting wire which requires the operating temperature to be maintained at well below the critical temperature of the superconducting wire at the required operating current and field strength. Conventionally the cryogenic fluid is liquid helium which boils at a temperature of 4.2K at atmospheric pressure, and the heat load on the inner reservoir of the cryogenic vessel from the external environment is often minimized by use of a liquid nitrogen vessel which maintains a first stage thermal shield enclosing the inner reservoir close to a temperature of 77K (the boiling point of liquid nitrogen at atmospheric pressure) to intercept most of the heat load before it reaches the inner reservoir. The temperature of the inner reservoir is maintained by evaporative cooling, i.e. the heat load causes the liquid helium to boil off. The same is true of the liquid nitrogen vessel connected to the surrounding thermal shield. It is thus necessary to refill or top up the liquid helium in the inner reservoir and the liquid nitrogen in the liquid nitrogen vessel after a period of time, that is typically after several months for the liquid helium and after a few weeks for the liquid nitrogen. Furthermore it is common for a secondary thermal shield to be placed between the first stage thermal shield and the inner reservoir, and this is cooled using the enthalpy of evaporating helium gas from the inner reservoir, typically to a temperature in the range of 40 to 50K.

Technology now exists that allows the evaporating helium gas from within the inner reservoir to be reliquified in situ using the second stage of a closed cycle cryocooler. At the same time, the cooling power from the cryocooler is sufficient to cool a thermal shield surrounding the inner reservoir to a temperature of well below 77K, and typically in the range of 40 to 50K. If this technology is used, there is no need for liquid helium and nitrogen refills at intervals as is required in existing systems, which is a distinct advantage to many customers.

One major disadvantage of the use of a cryocooler, however, is that, in the event of a power failure or malfunction of the cryocooler, the cooling is stopped. Instead of the cryocooler cold head acting as a source of cooling, it provides a significant heat path to the inner reservoir from the external environment. As a consequence the helium in the inner reservoir will rapidly boil off and, once the magnet has become uncovered, the magnet will start to warm up. If this happens the magnet will no longer be stable and will eventually quench, that is it will revert from the superconducting state to the normal state. If no helium is present in the inner reservoir, all of the magnet's stored energy will be dumped into the magnet itself. If the cryocooler cannot be restarted before there is a danger of this happening, either the inner reservoir will have to be refilled or the magnet will have to be de-energized to avoid the possibility of magnet damage in such a quenching step.

EP 1557624A2, EP 1619439A2, EP 1560035A1 and U.S. Pat. No. 5,144,810 each disclose a cryogenic system utilising a thermal shield surrounding an inner reservoir and cooled by a cryocooler so as to reduce the heat load on the inner reservoir during normal operation. However none of these references presents a solution to the above-described problem in the event of a power failure or malfunction of the cryocooler.

It is an object of the invention to provide a superconducting magnet system that does not require cryogenic fluid refilling at intervals but that is less sensitive to the effect of a power failure or malfunction as described above.

According to the present invention there is provided a superconducting magnet system comprising:

a superconducting magnet,

an inner reservoir within which the magnet is contained within a cryogenic fluid,

a cryocooler for condensing evaporated cryogenic fluid from the reservoir and for returning the condensed cryogenic fluid to the reservoir during normal operation, and

a thermal shield surrounding the inner reservoir and cooled by the cryocooler so as to reduce the heat load on the inner reservoir during normal operation,

wherein, in addition to the thermal shield, an inertial shield surrounds the inner reservoir and is arranged to be cooled by evaporated cryogenic fluid from the reservoir in the event that normal operation of the cryocooler is compromised as a result of a power failure or a fault, so as to reduce the heat load on the inner reservoir in such an event.

Thus, in the system in accordance with the invention, an inertial shield is arranged around the inner reservoir in a similar manner to a secondary thermal shield such as is used in a conventional evaporatively-cooled superconducting magnet system, in order to reduce the heat load on the inner reservoir in such a power failure or fault situation. However, by contrast with the secondary thermal shield used in the evaporatively-cooled system, the inertial shield is not cooled in normal operation, as there is no evaporated cryogenic fluid available to cool the shield down, so that it is redundant during normal operation of the system. Since the first stage thermal shield is typically at a temperature of 40 to 50K in the normal operating mode, there would normally be no substantial advantage in including a gas-cooled shield in addition to the first stage thermal shield. It is only when there is a power failure or a fault such that the cryogenic fluid starts to boil off as a result of the cryocooler ceasing to cool the fluid that the inertial shield is cooled by the evaporated cryogenic fluid from the inner reservoir and acts to significantly reduce the heat load on the inner reservoir.

As a result, the rate of boil-off of the cryogenic fluid from the inner reservoir due to the power failure or fault is significantly reduced, and the length of time before the magnet becomes uncovered is significantly increased. The details of how great this effect is depend on the exact configuration (geometry, construction of cryocooler, type of cold head, etc.). One of the largest effects can be due to the reduction in radiation load in this situation. The first stage of the cryocooler cold head, which in normal operation cools the thermal shield, rapidly warms up and as a result the thermal shield to which it is thermally linked also warms. Since radiation scales with the fourth power of absolute temperature, once this temperature has reached ˜75-80K, the radiative heat load on the inner reservoir is reduced by an order of magnitude due to the presence of the gas-cooled inertial shield which will typically be at a temperature of 40-50K. Calculations and experiments for several practical implementations of this invention show that the effect is to improve the “safe” time, that is the time before intervention is required, from about two days to over a week. This difference is enough to make the technology practical in locations or during periods where a cryocooler failure may not be rectifiable in a period of less than two days duration (for example due to unavailability of spare parts, helium supply, inaccessibility for a service engineer on short timescales, frequent power blackouts, or staff holidays/closed periods preventing the failure being acted upon in time).

The invention also provides a method of cryogenically cooling a superconducting magnet, comprising:

supplying cryogenic fluid to an inner reservoir within which the magnet is contained so as to be cooled by the cryogenic fluid,

supplying current to the magnet in order to initiate superconducting current flow in the magnet,

stopping the supply of current to the magnet whilst the superconducting current flow persists in the magnet,

condensing evaporated cryogenic fluid from the inner reservoir by means of a cryocooler and returning the condensed cryogenic fluid to the inner reservoir during normal operation of the cryocooler,

cooling a thermal shield surrounding the inner reservoir by means of the cryocooler so as to reduce the heat load on the inner reservoir during normal operation, and

in the event of a power failure or a fault compromising the normal operation of the cryocooler, cooling an inertial shield surrounding the inner reservoir by evaporated cryogenic fluid from the reservoir so as to reduce the heat load on the inner reservoir.

In order that the invention may be more fully understood, several embodiments of superconducting magnet system in accordance with the invention will now be described, by way of example, with reference to the accompanying drawings, in which:

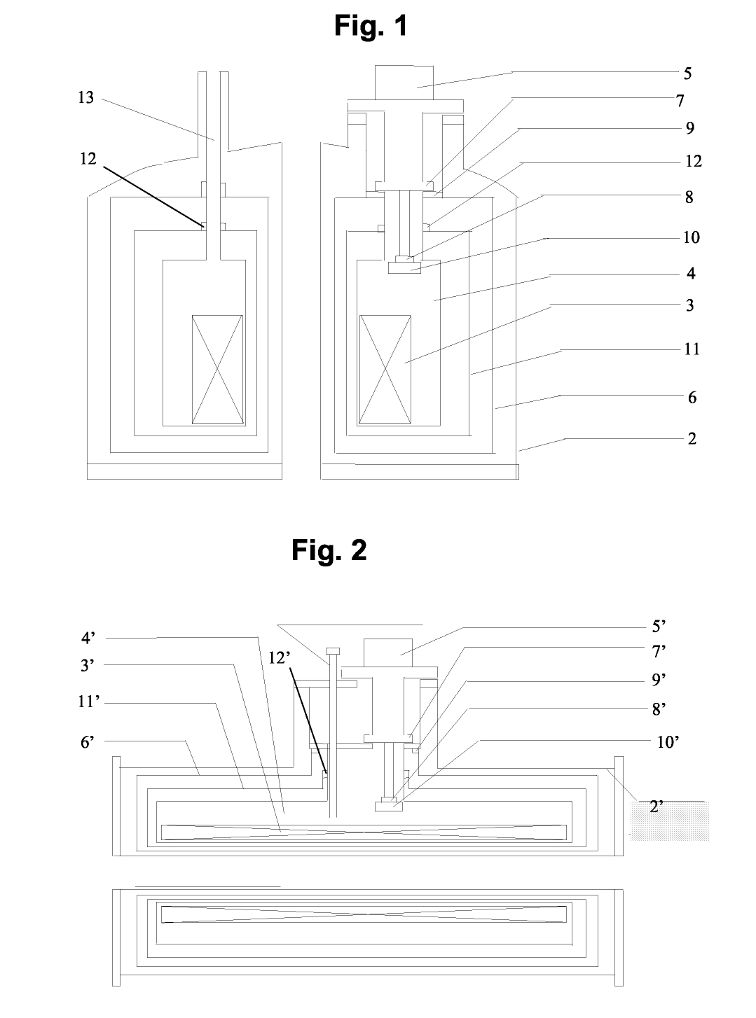

FIG. 1 is a schematic diagram of a first embodiment; and

FIG. 2 is a schematic diagram of a second embodiment.

The superconducting magnet system of FIG. 1 of the drawings is a vertical system having a vertically disposed magnet axis and intended for high field NMR spectroscopy. However it will be well understood that similar systems may be used in other applications.

Referring to FIG. 1 the superconducting magnet system comprises an annular cryogenic vessel 1 (shown in axial section so that only two opposite parts angularly offset by 120 degrees relative to one another can be seen in the figure) having an outer vacuum container 2 and containing a superconducting magnet 3 comprising magnet coils (not shown in detail). The magnet 3 is housed within an inner chamber inside a stainless steel annular reservoir 4 for containing liquid helium boiling at normal atmospheric pressure at about 4.2K, the magnet 3 and the reservoir 4 being suspended from the top wall of the outer vacuum container 2 by means of two additional necks 13.

Central to the operation of the superconducting magnet system is a cryocooler 5 (which in this specific embodiment is a pulse-tube cryorefrigerator) connected to the top of the reservoir 4 and acting to provide cooling power at cryogenic temperatures. Such a cryocooler 5 or pulse-tube cryorefrigerator has a first stage 7 that can be mechanically used to cool associated apparatus and a second stage 8 that serves to recondense evaporating helium gas from the reservoir 4. Specifically the cryocooler 5 used in the first embodiment produces 20 Watts of cooling power at the first stage 7 at a temperature of around 50K and a further 0.5 Watts of cooling power available at the second stage 8 at a temperature of about 4K. The first stage 7 of the cryocooler 5 is linked by a thermal link 9 to a solid thermal shield 6 made of high conductivity aluminium within the vacuum space surrounding the reservoir 4. This thermal shield 6 intercepts radiated and conducted heat loads from the outer vacuum container 2 that would otherwise cause very high helium loss from the reservoir 4. The second stage 8 of the cryocooler 5 then reduces the helium consumption to zero by recondensing the evaporating helium gas from the reservoir 4. The second stage 8 is fitted with a vapour condenser 10, that is a porous metal block that extends the surface area of the second stage 8 and results in efficient liquefaction of the evaporating gas.

In the absence of special measures, such a cryocooled shield 6 would warm up quickly in the event of a power failure as it would no longer be cooled by the cryocooler 5 and would radiate heat onto the reservoir 4 causing all of the liquid helium to evaporate. In order to slow down this rate of loss of helium it is necessary to introduce thermal inertia of some kind, associated with the liquid helium reservoir 4 so that this will take a long time to warm up. Unfortunately few materials possess this property at cryogenic temperatures. One material that does possess this property is the cold evaporating helium gas from the reservoir 4 itself. Accordingly, in the embodiment of FIG. 1, an inertial shield 11 is provided between the reservoir 4 and the thermal shield 6 with thermal links 12 in such a position that the outgoing helium gas from the reservoir 4 in the event of a power failure or failure of the cryocooler 5 carries away much of the heat being transferred to the inertial shield 11 from the thermal shield 6 and thus slows down the rate at which the thermal inertial shield 11 warms up in such an event.

It will be appreciated that, in normal operation of the cryocooler 5, there will be no outgoing gas from the reservoir 4 to cool the inertial shield 11, and that the inertial shield 11 only comes into effect under non-equilibrium conditions when the cryocooler no longer performs its cooling function and the system is warming up.

In addition to the neck down which the cryocooler fits, the necks 13 supporting the magnet 3 and the reservoir 4 are thermally linked to the various cold radiation shields (that is the thermal shield 6, the inertial shield 11 and the other shields forming the reservoir walls, etc.) in order to reduce conducted heat input to the reservoir. Furthermore these necks 13 extending through the top wall of the outer vacuum container 2 define a supply passage allowing the current leads (not shown) to the magnet 3 to be inserted into the vessel 1, as well as the other electrical connecting leads, including the lead to a liquid helium level monitor within the inner reservoir 4.

The superconducting magnet system of FIG. 2 of the drawings is a horizontal system having a horizontally disposed magnet axis and intended for high field MRI spectroscopy. However it will be well understood that similar systems may be used in other applications. In this figure similar parts are denoted by the same reference numerals primed as in FIG. 1.

Referring to FIG. 2 the superconducting magnet system comprises an annular cryogenic vessel 1′ (shown in axial section so that only two opposite parts angularly offset by 180 degrees relative to one another can be seen in the figure) having an outer vacuum container 2′ and containing a superconducting magnet 3′. The magnet 3′ is housed within an inner chamber inside a stainless steel annular reservoir 4′ for containing liquid helium, the magnet 3′ and the reservoir 4′ being suspended from the top wall of the outer vacuum container 2′ by means of high tensile GRP rods (not shown).

A cryocooler 5′ (which in this specific embodiment is a pulse-tube cryorefrigerator) connected to the top of the reservoir 4′ comprises a first stage 7′ that can be mechanically used to cool associated apparatus and a second stage 8′ that serves to recondense evaporating helium gas from the reservoir 4′. Specifically the cryocooler 5′ used in this embodiment produces 40-50 Watts of cooling power at the first stage 7′ at a temperature of around 50K and a further 1-2 Watts of cooling power available at the second stage 8′ at a temperature of about 4K. The first stage 7′ of the cryocooler 5′ is linked by a thermal link 9′ to a solid thermal shield 6′ made of high conductivity aluminium within the vacuum space surrounding the reservoir 4′. The second stage 8′ of the cryocooler 5′ then reduces the helium consumption to zero by recondensing the evaporating helium gas from the reservoir 4′. The second stage 8′ is fitted with a vapour condenser 10′.

As in the embodiment of FIG. 1, an inertial shield 11′ is provided between the reservoir 4′ and the thermal shield 6′ with a thermal link 12 in such a position that the outgoing helium gas from the reservoir 4′ in the event of a power failure or failure of the cryocooler 5 carries away the heat being transferred to the inertial shield 11′ from the thermal shield 6′ and thus slows down the rate at which the thermal inertial shield 11′ warms up in such an event.

As a result, the rate of boil-off of the helium from the inner reservoir due to the power failure or fault is significantly reduced, and the length of time before the magnet becomes uncovered is significantly increased.

What is claimed is:

1. A superconducting magnet system comprising:
a superconducting magnet;
an inner reservoir within which the magnet is contained within a cryogenic fluid;
a cryocooler for condensing evaporated cryogenic fluid from the reservoir and for returning the condensed cryogenic fluid to the reservoir during normal operation; and
a thermal shield surrounding the inner reservoir and cooled by the cryocooler so as to reduce the heat load on the inner reservoir during normal operation,
wherein, in addition to the thermal shield, an inertial shield surrounds the inner reservoir and is positioned so as to be cooled by being contacted by evaporated cryogenic fluid that has escaped from the inner reservoir in the event that normal operation of the cryocooler is compromised as a result of a power failure or a fault, so as to reduce the heat load on the inner reservoir in such an event.

2. (canceled)

3. The superconducting magnet system according to claim 1, further comprising cryogenic fluid supply means for supplying cryogenic fluid to the inner reservoir and for subsequently stopping supply of cryogenic fluid to the inner reservoir.

4. The superconducting magnet system according to claim 3, further comprising current supply means for supplying current to the magnet by way of a supply passage in order to initiate superconducting current flow in the magnet, and for subsequently stopping the supply of current to the magnet whilst the superconducting current flow persists in the magnet,

5. The superconducting magnet system according to claim 4, wherein the cryocooler comprises a first stage thermally linked to the thermal shield and a second stage for condensing evaporated cryogenic fluid from the inner reservoir and for returning the condensed cryogenic fluid to the inner reservoir.

6. The superconducting magnet system according to claim 5, wherein the cryocooler comprises a vapour condenser in the vicinity of the inner reservoir.

7. The superconducting magnet system according to claim 6, wherein the inertial shield is disposed in an annular space between the inner reservoir and the thermal shield.

8. The superconducting magnet system according to claim 7, wherein the cryocooler is disposed above the inner reservoir.

9. The superconducting magnet system according to claim 8, wherein a service neck extends through an outer casing of the system for the supply of cryogenic fluid to the inner reservoir.

10. The superconducting magnet system according to claim 9, wherein the magnet is annular and is disposed with its axis horizontal within a horizontal cryogenic vessel.

11. The superconducting magnet system according to claim 9, wherein the magnet is annular and is disposed with its axis vertical within a vertical cryogenic vessel.

12. A method of cryogenically cooling a superconducting magnet, comprising:
supplying cryogenic fluid to an inner reservoir within which the magnet is contained so as to be cooled by the cryogenic fluid;
supplying current to the magnet in order to initiate superconducting current flow in the magnet;
stopping the supply of current to the magnet whilst the superconducting current flow persists in the magnet;
condensing evaporated cryogenic fluid from the inner reservoir by means of a cryocooler and returning the condensed cryogenic fluid to the inner reservoir during normal operation of the cryocooler; and
cooling a thermal shield surrounding the inner reservoir by means of the cryocooler so as to reduce the heat load on the inner reservoir during normal operation;
in the event of a power failure or a fault compromising the normal operation of the cryocooler, an inertial shield surrounding the inner reservoir is cooled by being contacted by evaporated cryogenic fluid that has escaped from the inner reservoir so as to reduce the heat load on the inner reservoir.

13. The superconducting magnet system according to claim 10, wherein the cryogenic fluid is helium.

14. The superconducting magnet system according to claim 11, wherein the cryogenic fluid is helium.
